(19) United States
(12) Patent Application Publication
(10) Pub. No.: US 2026/0231293 A1
(43) Pub. Date: Aug. 6, 2026

(54) SYSTEM FOR DATA CHANNEL SERVICE FOR NEXT GENERATION 911 CALLS

(71) Applicant: T-MOBILE INNOVATIONS LLC, Overland Park, KS (US)

(72) Inventors: William Michael Hooker, Seattle, WA (US); A. Karl Corona, Maple Valley, WA (US)

(21) Appl. No.: 19/044,208

(22) Filed: Feb. 3, 2025

(51) Int. Cl. H04W 76/50; H04L 65/1016; H04W 8/22

(52) U.S. Cl. CPC H04W 76/50; H04L 65/1016; H04W 8/22

(57) ABSTRACT

Systems, methods, and devices are disclosed herein for providing data channel service for multimedia communication for emergency services calls in wireless communication networks in various implementations. In one example, a method comprises, by a call control function in a wireless network, connecting an emergency services call between a first endpoint and a second endpoint. Connecting the emergency services call comprises receiving, from the first endpoint, the emergency services call to the second endpoint, wherein the emergency services call comprises an indication of data channel capability of the first endpoint; establishing emergency voice call service between the first endpoint and the second endpoint; offering data channel service to the second endpoint; receiving acceptance of the data channel service from the second endpoint; and establishing a data channel between the first endpoint and the second endpoint in association with the emergency voice call service.

### TECHNICAL FIELD

Aspects of the disclosure are related to the field of wireless communication networks, particularly emergency services call handling and IMS data channel technology.

### BACKGROUND

Next Generation 911 (NG911) is a modernized emergency communications infrastructure intended to replace legacy 911 systems, enabling the use of IP-based communication protocols to handle voice, text, image, and video messages. NG911 leverages Session Initiation Protocol (SIP) for voice and multimedia data transport over IP, making it compatible with a wide range of devices beyond traditional phones, such as smartphones, voice over IP (VoIP), and other internet-connected devices. At the core of NG911 is the Emergency Services IP Network, an IP network which interconnects multiple Public Safety Answering Points (PSAPs) across regions, enabling interoperable communication.

However, rolling out NG911 poses challenges such as the significant cost of upgrading legacy infrastructure and ensuring cybersecurity for the new IP-based system. Additionally, coordination among diverse stakeholders, including federal, state, and local agencies, can be complex and time-consuming. As a result, the transition to NG911 has been uneven across jurisdictions, potentially delaying the full realization of its benefits in some areas.

### OVERVIEW

Technology is disclosed herein for providing data channel service for multimedia communication for emergency services calls in the context of wireless communication networks in various implementations. In one example, a method comprises, by a call control function in a wireless communication network, connecting an emergency services call between a first endpoint and a second endpoint, wherein the first endpoint comprises a calling device associated with a caller having an emergency, wherein the second endpoint comprises a public safety answering point (PSAP). Connecting the emergency services call comprises receiving, from the first endpoint, the emergency services call to the second endpoint, wherein the emergency services call comprises an indication of data channel capability of the first endpoint; establishing emergency voice call service between the first endpoint and the second endpoint; offering data channel service to the second endpoint; receiving acceptance of the data channel service from the second endpoint; and establishing a data channel between the first endpoint and the second endpoint in association with the emergency voice call service.

In another example, a computing apparatus comprises one or more computer readable storage media, one or more processors operatively coupled with the one or more computer readable storage media and program instructions stored on the one or more computer readable storage media that, when executed by the one or more processors, direct the computing apparatus to connect, by a call control function of a wireless communication network, an emergency services call between a first endpoint and a second endpoint. To connect the emergency services call, the program instructions direct the computing apparatus to receive, from a first endpoint, the emergency services call to the second endpoint, wherein the emergency services call comprises an indication of data channel capability of the first endpoint; offer data channel service to the second endpoint; receive acceptance of the data channel service from the second endpoint; and establish a data channel between the first endpoint and the second endpoint in association with the emergency services call.

In yet another example of the technology disclosed herein, one or more computer readable storage media having program instructions stored thereon that, when executed by one or more processors, direct a computing apparatus to connect, by a call control function of a wireless communication network, an emergency services call between a first endpoint and a second endpoint. To connect the emergency services call, the program instructions direct the computing apparatus to receive, from a first endpoint, the emergency services call to the second endpoint, wherein the emergency services call comprises an indication of data channel capability of the first endpoint; offer data channel service to the second endpoint; receive acceptance of the data channel service from the second endpoint; and establish a data channel between the first endpoint and the second endpoint in association with the emergency services call.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for data channel service for emergency services calls in an implementation.

FIG. 2 illustrates a process for data channel service for emergency services calls in an implementation.

FIGS. 3A-3C illustrate operational environments for data channel service during emergency services calls in an implementation.

FIGS. 4A-4D illustrate workflows for data channel service for emergency services calls in an implementation.

FIG. 5 illustrates a workflow for data channel service for emergency services calls in an implementation.

FIG. 6 illustrates a workflow for data channel service for emergency services calls in an implementation.

FIG. 7 illustrates an operational architecture for hosting data channel capability to provide data channel service for emergency services calls on a wireless communication network in an implementation.

FIG. 8 illustrates an operational architecture for a wireless communication network in an implementation.

FIG. 9 illustrates an operational architecture for a wireless communication network in an implementation.

FIG. 10 illustrates a computing system suitable for implementing the various operational environments, architectures, processes, scenarios, and sequences discussed below with respect to the other Figures.

### DETAILED DESCRIPTION

Although the descriptions provided herein may be in the context of certain radio access technologies, networks, and network topologies, such as 5G-NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrowband Internet of Things (NB-IoT), vehicle-to-everything (V2X), fixed wireless internet, and non-terrestrial network (NTN) communications. Thus, the scope of the disclosure is not limited to the examples described herein.

Various implementations are disclosed herein for supporting enhanced Next Generation 911 (NG911) calls over wireless communication networks, including support for data channel service for multimedia IMS communications in scenarios where one or more of the network domains or endpoints lack a native IMS infrastructure. In various implementations, support for Internet Protocol Multimedia Service data channel (IMS DC) technology is enabled by a dedicated IMS DC network which includes a data channel server and application repository networked to the existing infrastructure by an IMS application server. Providing IMS DC support for NG911 calls ensures interoperability between the user equipment (UE) of the caller and the Public Safety Answering Point (PSAP) or 911 call center for enhanced communication such as sharing multimedia, text or other real-time data alongside voice communication. The enhanced communications facilitate information sharing by means other than just voice—applications can be deployed for videoconferencing as well as receiving text inputs (among other capabilities) without the need to have a particular application installed at either endpoint of the call and irrespective of the type of device either endpoint is using.

IMS data channel is a protocol extension within the IMS that facilitates real-time, peer-to-peer data communication alongside traditional voice and video services. Built on WebRTC (Web Real-Time Communication) technologies, IMS data channel supports a variety of use cases, including rich communication services, enhanced messaging, and interactive applications like gaming or screen sharing, within an IMS-controlled environment. IMS data channel integrates with the SIP signaling protocols of IMS, providing end-to-end session management and Quality of Service control over IP networks. IMS data channel can be deployed within wireless network infrastructures, enabling seamless transitions and support for advanced, real-time data-driven applications for communication services that require data exchange without interrupting ongoing voice or video sessions.

To enable IMS DC capability for NG911 calls, an IMS DC function is implemented within the infrastructure of a domain which carries or receives NG911 calls, such as the mobile network operator (MNO) network, the Emergency Services IP Network (ESInet), or the PSAP to which an NG911 call has been routed. The IMS DC function may be networked to the existing infrastructure of a domain by means of an IMS application server with data channel capability. For example, the IMS DC function may connect to an application server of an IMS network core of the MNO, such as a Telephony Application Server (TAS) connected to an Emergency Call Session Control Function (E-CSCF) of the IMS core. On other scenarios, an IMS application server with data channel support may interconnect an IMS DC function with a gateway functionality (e.g., Interconnect Session Border Controller (ISBC)) of an ESInet or of a PSAP. When an endpoint of an NG911 call (e.g., the UE or PSAP) invokes a data channel for the call, the IMS DC function invites the other endpoint to accept data channel service, then establishes a data channel bearer between the two endpoints in association with (e.g., bootstrapped to) the voice Real-time Transport Protocol (RTP) bearer. The data channel can then be used for exchanging different kinds of multimedia data or information in real-time, such as situational information which may be critical to an emergency response. Moreover, if a new endpoint joins the existing NG911 call (e.g., a first responder is conference into the call), the new endpoint can also be joined to the established data channel.

In an implementation, an IMS DC function initiates a data channel bearer to be bootstrapped or established in parallel to a voice call as an additional media stream, thereby augmenting the call with multimedia service and peer-to-peer communication. The additional media stream carried by the bootstrapped data channel may include screen or application sharing in real-time between the end-user device and the PSAP. The end-user device and the PSAP can view and interact with, for example, a shared application which captures information from the user and displays it in a user interface for the call-taker. In various implementations, the IMS DC function may include functionalities, such as an IMS DC server (DCS) and an IMS DC application repository (DCAR), for tasks such as establishing the bearer for the data channel and for hosting and serving content (applications, webpage content, etc.) carried by the data channel. Other functional elements of the IMS DC function may include a data channel signaling function (DCSF) or data channel media function (DCMF).

In an exemplary scenario enabled by the technology disclosed herein, when a user makes a NG911 call to a PSAP or 911 call center, an IMS DC bearer is bootstrapped to the voice call to transmit an application or other media to the user device for any of a number of different tasks relating to the purpose of the call. For example, using IMS DC, as the voice call is live, an application may be deployed to the user device to display a user interface which prompts the user to key in information about the emergency or alerts the user to the status of their call when the call is queued. An IMS DC application may also enable videoconferencing between the end-user device and the PSAP or first responder without the need for all parties to have installed (or be subscribed to) a particular “over the top” videoconferencing application. These types of enhancements to the voice call can be deployed irrespective of the type of device so long as the device supports IMS DC, thus overcoming barriers to interoperability. In addition, in an emergency, when an NG911 call is queued due to a high volume of incoming calls, the caller can still provide important information about the emergency to expedite the response when the call eventually reaches a call-taker at the call center. Indeed, such applications may also be used to provide transcription or translation services for the caller or to triage incoming NG911 calls according to the type or severity of emergency or response required. Moreover, the deployment of an application via IMS DC is a largely seamless process for the caller, requiring the caller only to accept the application during the call.

A call flow for establishing an IMS DC bearer in concert with a NG911 call follows. In the following scenario, the IMS DC function is hosted by the wireless communication network of an MNO. When a user places an NG911 call on a user equipment (UE) such as a smartphone, a SIP INVITE message is sent to the network which includes an identifier such as a SOS-type or 911-type Uniform Resource Name (URN) identifying the call as an emergency call. One or more network functions of the wireless communication network identifies the geographic location of the UE and determines to which PSAP the call should be routed.

In various implementations, the NG911 call from the UE to the carrier network includes an indication that the UE has IMS DC capability. For example, the SIP INVITE message for the call from the UE may advertise support for IMS DC capability in the SIP header while also invoking IMS DC service. In other scenarios, the UE indicates IMS DC capability in the SIP INVITE message, and the carrier network queries the UE to accept a Re-INVITE or UPDATE message for IMS DC service after the PSAP confirms support for IMS DC service. In any case, with both endpoints accepting IMS DC service, the IMS DC bearer is set up for exchanging data between the UE and the PSAP. In still other scenarios, the data channel bearer is established after the voice call is under way. For example, after the voice call bearer is established, the data channel bearer may be bootstrapped to the call by means of the PSAP accepting a SIP Re-INVITE message requesting acceptance of IMS DC service and the UE accepting a SIP INVITE requesting acceptance of IMS DC service.

In some implementations, an IMS DC function for providing data channel service is hosted by the ESInet or the PSAP. When the IMS DC function is hosted by the ESInet, the UE indicates its IMS DC capability in the outgoing SIP INVITE message, and the ESInet sends a SIP INVITE message requesting support for IMS DC service to the PSAP. When the PSAP accepts the invite, the ESInet sends a Re-INVITE message for data channel service to the UE. When the UE accepts the Re-INVITE, the ESInet establishes the bearer for the data channel.

Alternatively, when the IMS DC function is hosted by the PSAP, when the SIP INVITE from the UE advertises IMS DC capability, it is the IMS DC function at the PSAP which sends a Re-INVITE to the UE to accept data channel service.

Technical effects of the technology disclosed herein include enabling IMS DC service between a UE and an PSAP for enhanced communication, ensuring interoperability for multimedia transmissions during NG911 calls and enhancing communication in critical situations. In particular, implementations of the technology disclosed herein can be used in scenarios where PSAPs lack an infrastructure for supporting IMS data channel capability. Because the process of upgrading PSAPs to support IMS data channel capability may take years to fully roll out, the technology disclosed herein brings to fruition IMS data channel capability for NG911 calls regardless of whether a PSAP can host such IMS data channel functionality.

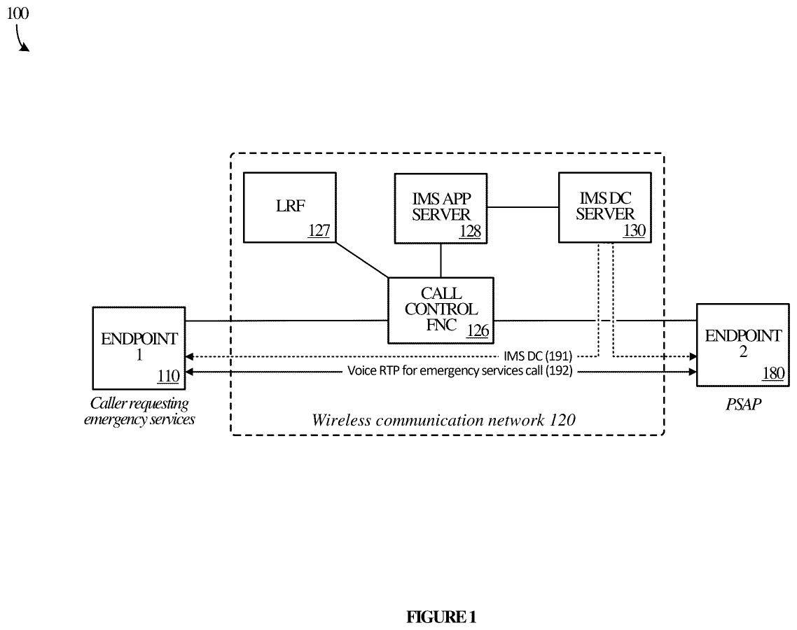

Turning now to the Figures, FIG. 1 illustrates operational environment 100 for data channel service for emergency services calls in the context of wireless communication network in an implementation. Operational environment 100 includes endpoint 110, endpoint 180, and wireless communication network 120. Wireless communication network 120 includes call control function 126, location and routing function (LRF) 127, IMS application server 128, and IMS DC server 130. Operational environment 100 also includes IMS DC bearer 191 and voice call bearer 192.

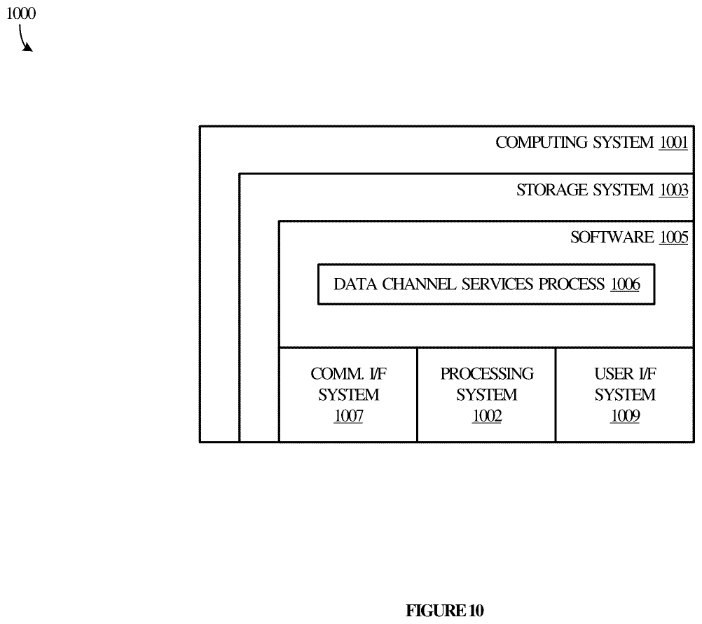

Endpoint 110 (“UE 110”) is representative of a UE such as a mobile computing device, smartphone, cellular phone, tablet computer, wearable device, Internet of Thing (IoT) device, or enhanced mobile broadband (eMBB) device, of which computing system 1001 in FIG. 10 is representative. Endpoint 110 includes processing circuitry for wireless communication including multimedia communication, e.g., IMS voice, text, video, or data transmission, hosted by a wireless communication network such as wireless communication network 120. Endpoint 110 exchanges wireless communication signals with base stations or access nodes of wireless communication networks over radio frequency (RF) bands according to protocols such as Fifth Generation New Radio (5G-NR), 5G Advanced, 4G/LTE, 6G, Institute of Electrical and Electronic Engineers (IEEE) 802.11 (WiFi), Low-Power Wide Area Network (LP-WAN), Near-Field Communications (NFC), Code Division Multiple Access (CDMA), Frequency Division Multiple Access (FDMA), and Time Division Multiple Access (TDMA).

Endpoint 180 (“PSAP 180”) is representative of an endpoint for receiving Next Generation 911 calls, such as a PSAP or 911 call center. Endpoint 180 may include functionality for communication with other network entities, such as an emergency services IP network or a wireless communication network for emergency services calls such as NG911 calls.

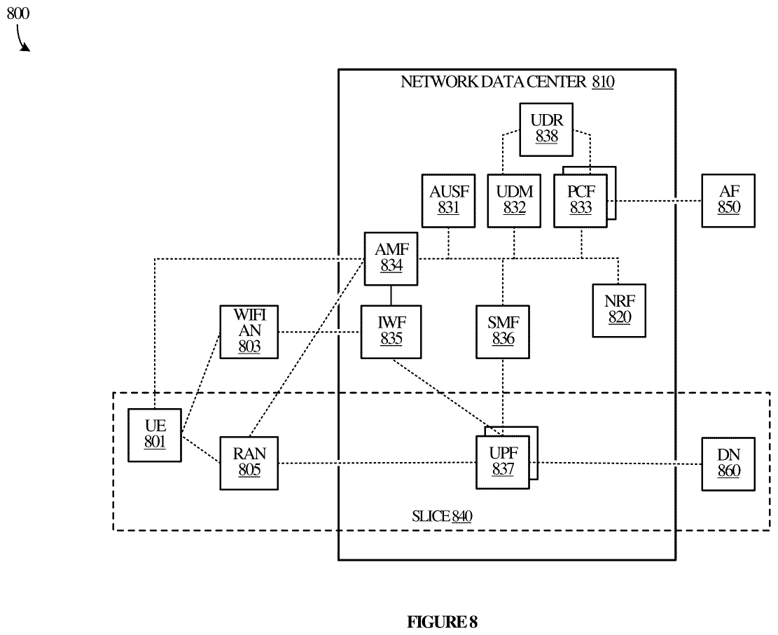

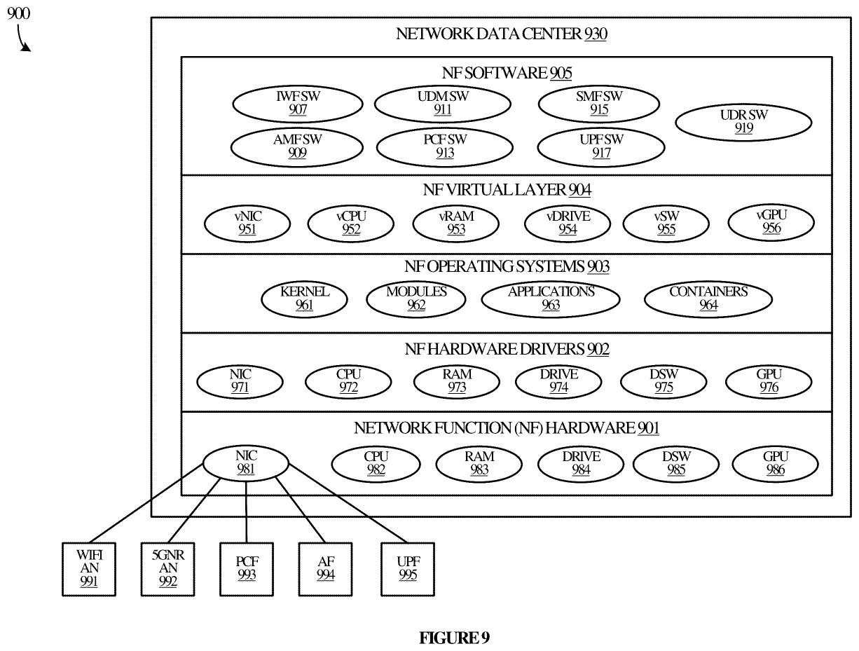

Wireless communication network 120 is representative of a communication network capable of using a Fifth Generation New Radio (5G-NR), 4G LTE, 6G, or other protocol to communicate with devices such as UE 110. Wireless communication network 120 may include multiple independently operated networks (not shown) by which a call is routed between endpoint 110 and endpoint 180, such as a mobile network operator (MNO) network, an ESInet, and a PSAP LAN. In some scenarios, wireless communication network 120 may be a service-based architecture (SBA) which includes network functions which constitute the control plane and user plane of a wireless communication network core, of which network data center 810 of FIG. 8 and network data center 910 of FIG. 9 are representative. Network functions of wireless communication network 120 (e.g., call control function 126, LRF 127, etc.) are implemented on one or more suitable computing devices, of which computing device 1001 of FIG. 10 is representative. Examples of suitable computing devices include server computers, blade servers, and the like. The network elements of wireless communication network 120 may be implemented in the context of one or more data centers in a co-located or distributed manner, or in some other arrangement.

Call control function 126 of wireless communication network 120 is representative of a network function implemented in software or hardware for managing emergency voice call handling, such as an E-CSCF. Call control function 126 includes functionality for routing emergency voice call signaling from an originating network or endpoint (e.g., UE 110) to the appropriate Public Safety Answering Point (PSAP) or emergency service network. Call control function 126 may interface with other IMS entities such as LRF 127 for location information and service-specific logic to determine the correct emergency service destination. Call control function 126 may interface with IMS application server 128 to initiate data channel service for NG911 calls.

LRF 127 is representative of a network function implemented in software or hardware for determining routing and location information for NG911 calls, such as a gateway mobile location center (GMLC), a location retrieval function, or a routing determination function (RDF). LRF 127 retrieves and provides accurate location information for devices making emergency calls. LRF 127 interfaces with network elements, such as call control function 126 to ensure that precise location data is available for routing the call to the appropriate emergency services network and/or 911 call center.

IMS application server (IMS AS) 128 is representative of a network function implemented in software or hardware for delivering enhanced calling services (i.e., including IMS capability) to users, such as a TAS with IMS capability. In various implementations, IMS AS 128 includes functionality for real-time text (RTT) interworking, voice call handling (i.e., providing call control functions, including call setup, management, and teardown), and supports features such as call forwarding, voicemail, conference calling, billing, and call detail record (CDR) generation. In an implementation, IMS AS 128 also includes functionality for supporting IMS DC service, including interfacing with an IMS DC server such as IMS DC 130. IMS AS 128 may be implemented within the IMS infrastructure of a 5G network of an MNO of wireless communication network 120, in an emergency services network (not shown) by which endpoint 180 connects to wireless communication network 120, or by endpoint 180.

IMS data channel server (IMS DC) 130 is representative of a network function implemented in software or hardware for integration of data communication services for voice calls such as NG911 calls. IMS DC 130 may be implemented within the IMS infrastructure of a 5G network of an MNO of wireless communication network 120, in an emergency services network (not shown) by which endpoint 180 connects to wireless communication network 120, or by endpoint 180. IMS DC 130 supports the exchange of non-voice data, such as text messaging, multimedia sharing, and application-specific data, during or outside voice call sessions for real-time collaboration and interactive applications, within the IMS infrastructure.

A brief operational scenario of operational environment 100 follows. UE 110 places a NG911 call, hosted by wireless communication network 120, for emergency service. Upon receiving the SIP invite for the call, call control function 126 receives location and routing information from LRF 127 which indicates that the NG911 call should be routed to PSAP 180. Call control function 126 determines that UE 110 can support IMS DC service, either by detecting an indication of IMS DC support in the SIP invite of the call or by a request for IMS DC service in the SIP invite. As (or, in some scenarios, after) the NG911 call (i.e., voice call bearer 192) is established, call control function 126 transmits a request to IMS AS 128 for IMS DC service to PSAP 180. When PSAP 180 signals acceptance of the request for IMS DC service, IMS AS 128 establishes IMS DC bearer 191 in association with voice call bearer 192.

Continuing with the operational scenario, with the DC bearer established, a user (e.g., dispatcher) at PSAP 180 can launch an application hosted by a DC application repository (not shown) of IMS DC 130 to receive information from the caller at UE 110 relating to the emergency. For example, the application may surface text fields on a user interface (e.g., touchscreen or display) at UE 110 where the caller can key in information. Other kinds of applications may also be deployed (e.g., videoconferencing, language translation, instructions for performing CPR). When an application is selected and launched or deployed by PSAP 180, the caller at UE 110 accepts the application causing it to launch on UE 110. When the caller at UE 110 enters information in the application, IMS DC bearer 191 transmits the information to PSAP 180 where the dispatcher can receive it in, for example, a user interface of endpoint 180.

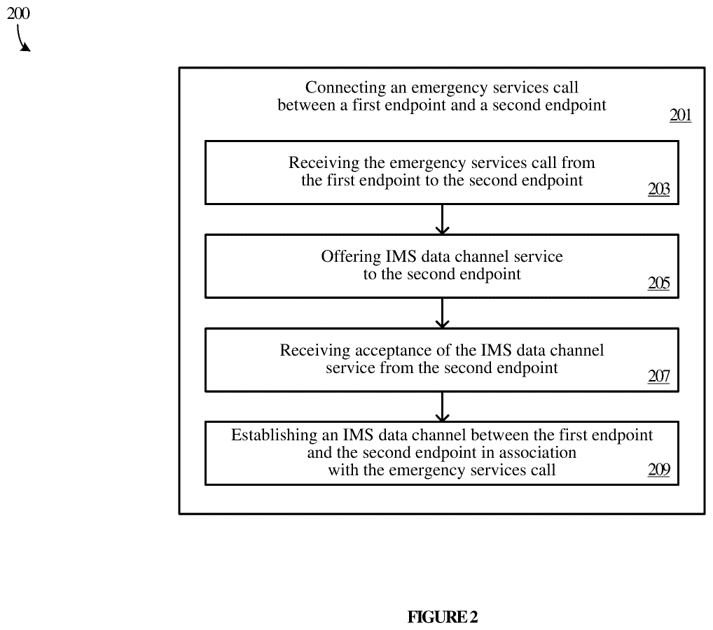

FIG. 2 illustrates a method for data channel service for emergency services calls in the context of wireless communication network in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

A computing device connects an emergency services call between a first endpoint and a second endpoint (step 201) in a method described in steps 203-209. In process 200, the first endpoint places an NG 911 call over a wireless network (e.g., 5G, LTE) to the second endpoint. The first endpoint may be a UE, such as a smartphone, and the second endpoint may be a PSAP or 911 call center. The call may be initiated by the first endpoint sending an SIP INVITE with an SOS URN which is received by the computing device. The computing device may include a call control function of the wireless network, such as an E-CSCF, for routing emergency services calls, e.g., NG911 calls.

The computing device receives the emergency services call from the first endpoint to the second endpoint (step 203). In placing the call, the first endpoint advertises IMS DC capability in the SIP header information but may also invoke or request IMS DC service in conjunction with the call.

The computing device offers IMS data channel service to the second endpoint (step 205). In an implementation, the computing device sends an invite (e.g., a SIP INVITE) to the second endpoint which includes an offer to accept IMS DC service in association with the NG911 call.

The computing device receives acceptance of the IMS data channel service from the second endpoint (step 207). In an implementation, the second endpoint signals acceptance of IMS DC service to the computing device in a SIP 183 response.

The computing device establishes an IMS data channel between the first endpoint and the second endpoint in association with the emergency services call (step 209). In an implementation, the call control function signals to an IMS AS to create an IMS data channel in association with the NG911 call. The IMS AS in turn signals an IMS DC server to establish the IMS DC bearer to serve IMS DC media to both the first and second endpoints. With the IMS DC established, the second endpoint may select, from a menu of applications, an application to be deployed via the IMS data channel to the first endpoint for enhancing communications between the two endpoints.

In some scenarios, the computing device is an ISBC of an emergency services network (ESInet) or an ISBC of the second endpoint. For example, the ISBC may communicate with a dedicated IMS application server which is networked to an IMS DC server. In some scenarios, the IMS data channel is established after the voice call is established and underway.

Referring again to FIG. 1, a brief example of process 200 as employed by elements of operational environment 100 follows. In operation, call control function 126 receives a SIP INVITE from endpoint 110 to connect a NG911 call to endpoint 180. The SIP INVITE advertises IMS DC capability of endpoint 110.

Call control function 126 offers IMS DC service to endpoint 180 and receives an acceptance of the invite from endpoint 180. In response, call control function 126 signals to IMS AS 128 (e.g., via a SIP INVITE) that an IMS data channel is to be created in association with the NG911 call. IMS AS 128 in turn signals IMS DC 130 to establish IMS data channel bearer 191 between endpoints 110 and 180. In requesting the establishment of IMS data channel bearer 191, IMS AS 128 may specify a call identifier for the NG911 call, Quality of Service (QoS) parameters, IP addresses and ports for endpoints 110 and 180, a channel type (e.g., real-time, bidirectional), and the like.

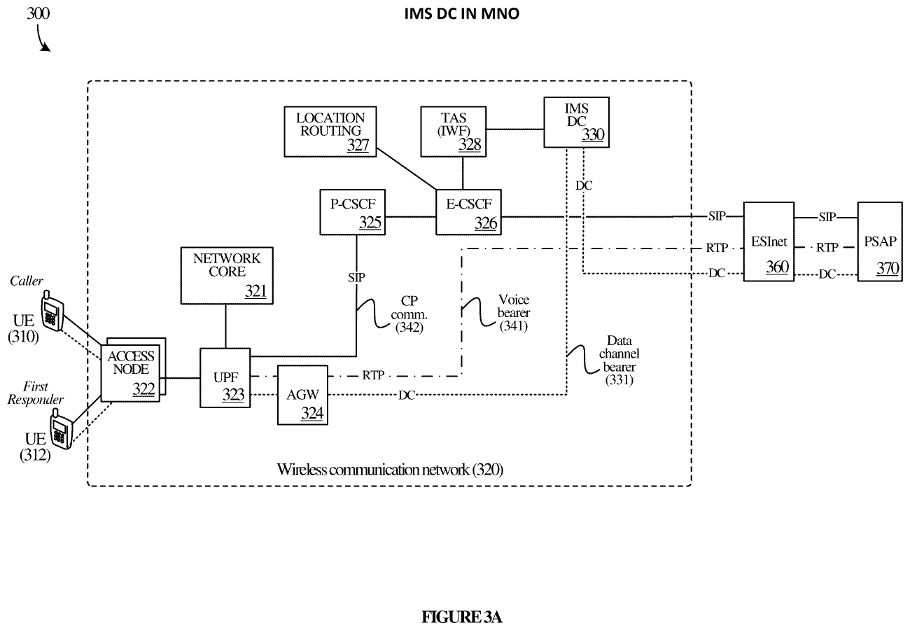

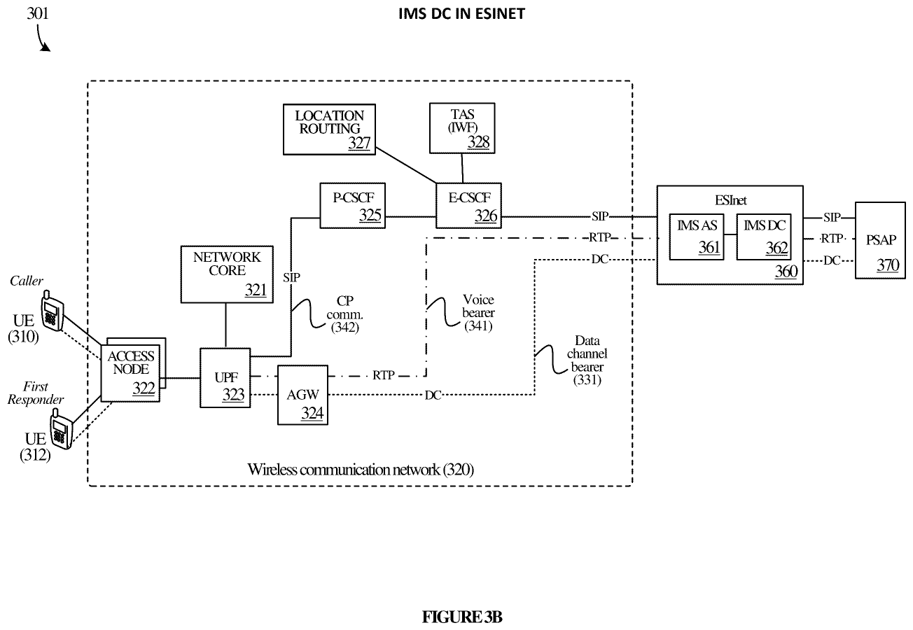

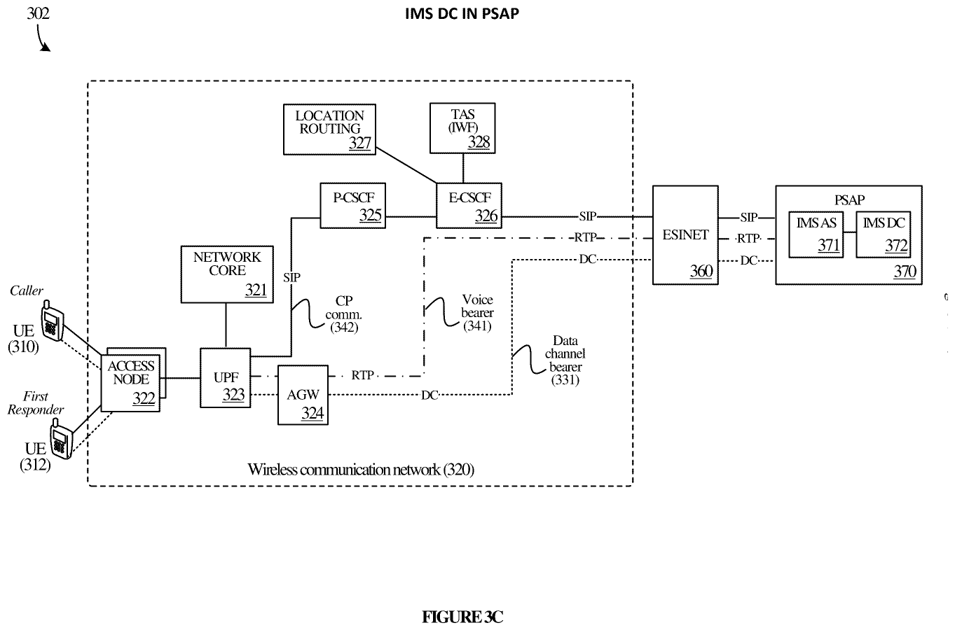

Next, FIGS. 3A, 3B, and 3C illustrate operational environments 300, 301, and 302, respectively, for data channel service for emergency services calls in the context of wireless communication networks in various implementations. Operational environments 300, 301, and 302 include wireless communication network 320, ESInet 360, and PSAP 370. Wireless communication network 320 includes network core 321, access node 322, user plane function (UPF) 323, access gateway (AGW) 324, proxy call session control function (P-CSCF) 325, emergency call session control function (E-CSCF) 326, location and routing function 327, and telephony application server (TAS) 328. Operational environment 300 also includes caller UE 310, first responder UE 312, data channel bearer 331, voice bearer 341, and control plan (CP) communication 342. Operational environment 300 of FIG. 3A also includes IMS DC 330 in wireless communication network 320; operational environment 301 of FIG. 3B includes IMS AS 361 and IMS DC 362 of ESInet 360; and operational environment 302 of FIG. 3C includes IMS AS 371 and IMS DC 372 of PSAP 370.

Wireless communication network 320 is representative of a communication network capable of using a Fifth Generation New Radio (5G-NR), LTE, 6G, or other protocol to communicate with computing devices such as UE 310. In an implementation, wireless network 320 is representative of a architecture, such as an SBA architecture, which includes network functions which constitute the control plane and user plane of a wireless communication network core, such as network core 321, of which network data center 810 of FIG. 8 and network data center 930 of FIG. 9 are representative. Network functions of wireless communication network 320 are implemented on one or more suitable computing devices, of which computing device 1001 of FIG. 10 is representative. Examples of suitable computing devices include server computers, blade servers, and the like. The network elements of wireless communication network 320 may be implemented in the context of one or more data centers in a co-located or distributed manner, or in some other arrangement.

The network functions or elements of wireless communication network 320 include IMS DC 330, UPF 323, AGW 324, P-CSCF 325, E-CSCF 326, location & routing function 327, and TAS 328, along with the various network functions of access node 322 and network core 321 (not shown for ease of illustration). It may be appreciated that wireless communication network 320 can include other network functions and elements, such as other network functions directly or indirectly related to IMS service and support, which are omitted for clarity.

Of the various network functions illustrated for wireless communication network 320, IMS DC 330 is representative of a functionality or logic for managing or controlling IMS DC operation for NG911 calls as well as functionality or logic for serving applications (e.g., IMS DC applications, WebRTC applications) or content (e.g., HTTP media) to endpoints of an NG911 call. UPF 323 is representative of a user plane function of wireless communication network 320 for handling user data including routing, forwarding, QoS enforcement, and traffic management for end-user applications. AGW 324 is representative of a function of wireless communication network 120 for routing user plane transmissions. P-CSCF 325 is representative of a function of wireless communication network 320 for SIP signaling, including managing and forwarding session requests between UEs and network core 321. E-CSCF 326 is representative of a network function for handling emergency call identification, retrieving caller location information, and routing the emergency call to the appropriate ESInet or PSAP based on the caller location.

Continuing with the network functions of wireless communication network 320, location and routing function 327 is representative of one or more network functions which identifies the location of UE and determines the appropriate ESInet and/or PSAP for receiving the call. In various implementations, location and routing function 327 includes a Gateway Mobile Location Center (GMLC), a Location Retrieval Function (LRF), and/or a Routing Determination Function (RDF). TAS 328 is representative of a network function for call control and telephony-related services in an IMS network of wireless communication network 320, such as call forwarding and conferencing, and which also includes IMS DC capability. TAS 328 may also be an interworking function (IWF) for bridging IMS and non-IMS networks or protocols. Communication between wireless communication network 320, ESInet 360, and PSAP 370 may relayed by network functions such as interconnect session border controllers (ISBCs) (not shown) which manage SIP signaling and media traffic between IMS networks and external domains such as ESInet 360 and PSAP domain 370.

Access node 322 is representative of one or more ground stations, base stations, or access nodes of wireless communication network 320. (It may be appreciated that UE 310 and UE 312 may connect with the same or different ones of access node 322.) Access node 322 can include Fifth Generation (5G) radio access networks (RANs), access nodes of long-term evolution (LTE) RANs, gNodeBs, eNodeBs, macrocells, NB-IoT access nodes, LP-WAN base stations, wireless relays, WiFi access nodes, and/or other wireless or wireline network transceivers. Access node 322 hosts access networks using radio frequencies to provide wireless network connectivity to devices such as UE 310 or UE 312. To communicate with network core 321 of wireless communication network 320, access node 322 may include receiving unit (RU) circuitry which communicates along fronthaul data paths to distributed unit (DU) circuitry which in turn communicates with central unit (CU) circuitry along midhaul data paths.

Each of UEs 310 and 312 is representative of a device, such as a smartphone, computer, sensor, controller, radio, and/or some other user apparatus, with processing circuitry for wireless communication with a wireless network of wireless network core 321 using protocols such as Fifth Generation New Radio (5GNR), 5G Advanced, LTE, 6G, Institute of Electrical and Electronic Engineers (IEEE) 802.11 (WiFi), Low-Power Wide Area Network (LP-WAN), Near-Field Communications (NFC), Code Division Multiple Access (CDMA), Frequency Division Multiple Access (FDMA), and Time Division Multiple Access (TDMA). UEs 310 and 312 can include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 1001 in FIG. 10 is broadly representative. UEs 310 and 312 exchanges wireless communication signals with access nodes, such as access node 322, of the wireless network over radio frequency bands.

ESInet 360 is representative of an emergency services IP network for routing NG911 calls and data to the appropriate PSAP, such as PSAP 370. ESInet 360 includes capability for IMS DC data transmission. PSAP 370 is representative of a public safety answering point for receiving and processing emergency voice calls routed through an ESInet such as ESInet 360. PSAP 370 includes capability for IMS DC data transmission.

FIG. 3B illustrates operational environment 301 for data channel service for emergency services calls in the context of wireless communication networks in an implementation. In operational environment 301, ESInet 360 includes IMS AS 361 and IMS DC function 362. For example, IMS AS 361 may be connected to an ISBC (not shown) of ESInet 360 for network connectivity.

IMS AS 361 is representative of an application server functionality with IMS DC 362 support for requesting and receiving data channel service, such as establishing a data channel bearer and serving content, such as applications, webpages, and the like, to the endpoints of the an NG911 call. IMS DC 362 is representative of a functionality or logic for managing or controlling IMS DC operation for NG911 calls as well as functionality or logic for serving applications (e.g., IMS DC applications, WebRTC applications) or content (e.g., HTTP media) to endpoints of an NG911 call.

FIG. 3C illustrates operational environment 302 for data channel service for emergency services calls in the context of wireless communication networks in an implementation. In operational environment 302, PSAP 370 includes IMS AS 371 and IMS DC 372. For example, IMS AS 371 may be connected to an ISBC (not shown) of PSAP 370 for network connectivity.

IMS AS 371 is representative of an application server functionality with IMS DC support for requesting and receiving data channel service, such as establishing a data channel bearer and serving content, such as applications, webpages, and the like, to the endpoints of the an NG911 call. IMS DC 372 is representative of a functionality or logic for managing or controlling IMS DC operation for NG911 calls as well as functionality or logic for serving applications (e.g., IMS DC applications, WebRTC applications) or content (e.g., HTTP media) to endpoints of an NG911 call.

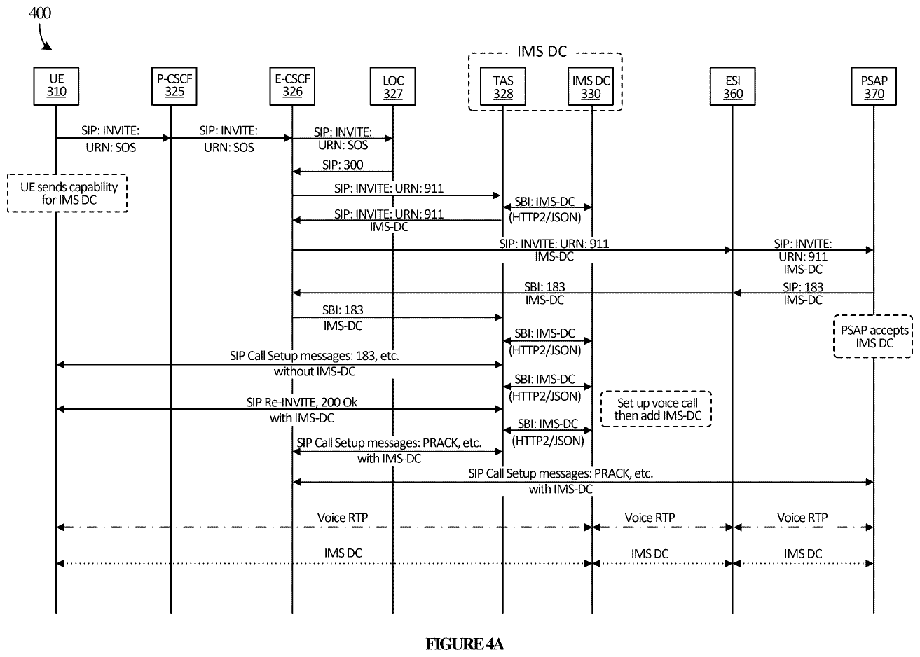

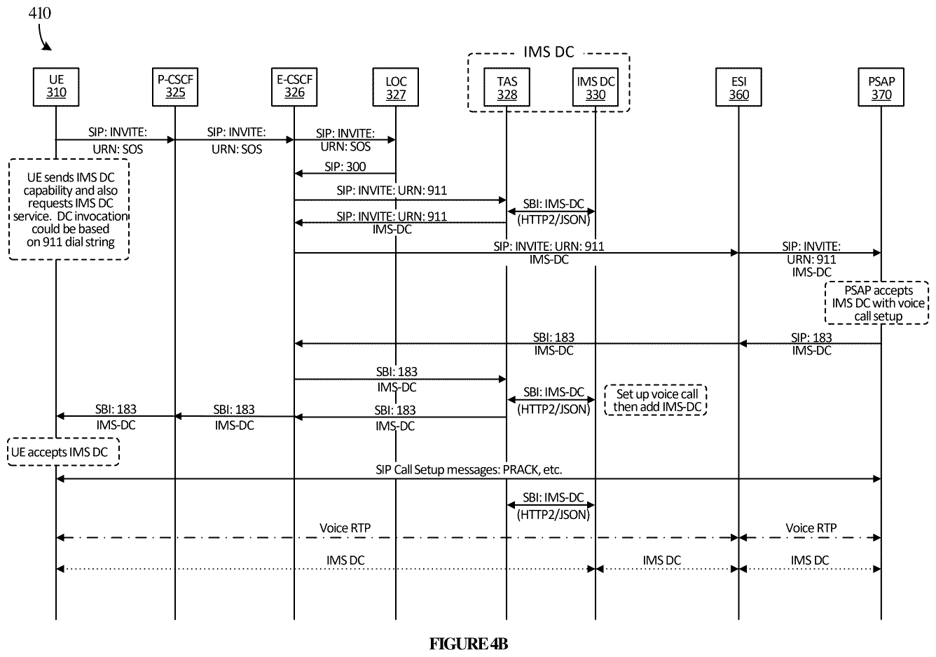

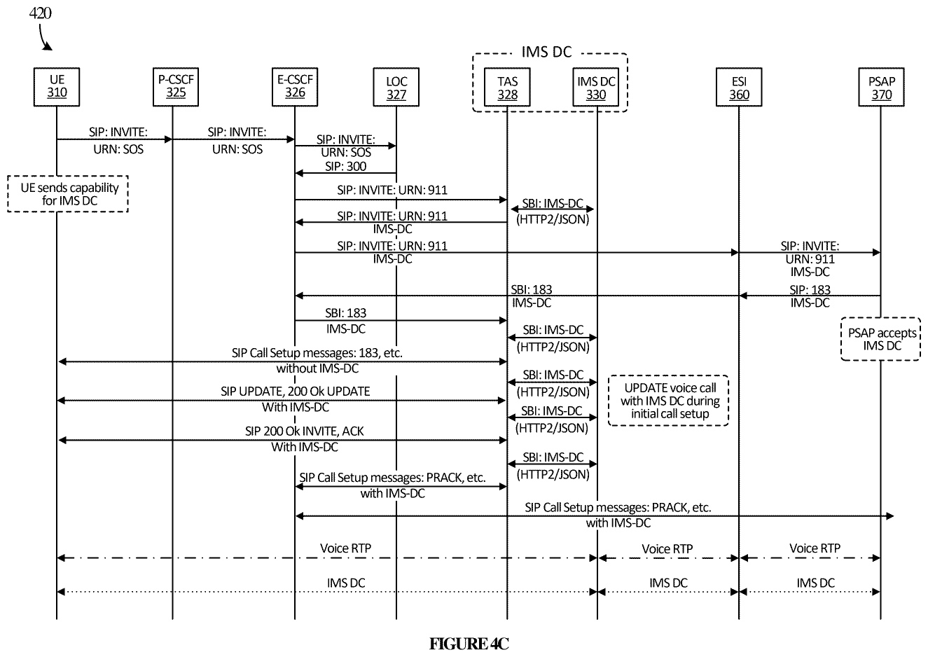

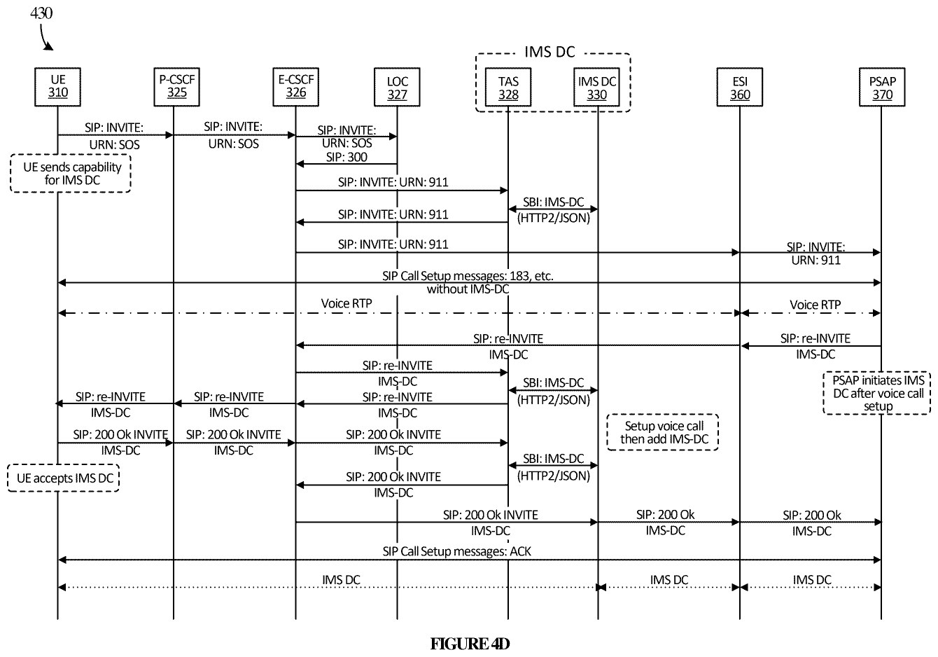

FIGS. 4A-4D illustrate workflows 400, 410, 420, and 430, respectively, for data channel service for emergency services calls in the context of wireless communication networks in various implementations and referring to elements of operational environment 300 of FIG. 3A. In workflow 400, an NG911 call from UE 310 is received by access node 322 and routed through wireless communication network 320 to P-CSCF 325 which identifies or determines that the call is an emergency voice call necessitating emergency handling. The NG911 call also advertises IMS DC capability. P-CSCF 325 routes the NG911 call to E-CSCF 326 which obtains the location of UE 310 from location and routing function 327. Location and routing function 327 also identifies PSAP 370 based on the location of UE 310 and identifies ESInet 360 as the appropriate ESI network for connecting the NG911 call to PSAP 370. In addition to determining the appropriate PSAP for the caller's location, location and routing function 327 may return information relating to any IMS DC capability of the identified PSAP; if, for example, a PSAP is known to not have IMS DC support or capability, unnecessary signaling relating to IMS DC can be avoided.

Next, with PSAP 370 identified, E-CSCF 326 signals TAS 328 to establish a data channel bearer for the call and transmits a SIP INVITE including a request to accept data channel service to PSAP 370 via ESInet 360 (for example, relayed between the respective ISBCs of wireless communication network 320, ESInet 360, and PSAP 370). TAS 328 in turn signals IMS DC 330 to configure the IMS DC bearer to serve IMS DC media to UE 310 PSAP 370.

Upon PSAP 370 accepting data channel service with the voice call setup, E-CSCF 326 sends a SIP 183 Session Progress (or INVITE Answer) to UE 310 accept the call, followed by a SIP Re-INVITE to also accept data channel service. When UE 310 accepts data channel service, the voice bearer for the voice call is set up between UE 310 and PSAP 370 along with a data channel bearer for data channel service.

Data channel service can include the transmission of data (e.g., applications, webpages) to UE 310 and PSAP 370 from an application repository of IMS DC function 330. For example, an operator at PSAP 370 may select an application to be transmitted to UE 310 for a capturing additional information relating to the call. When UE 310 accepts the application, the application may be displayed in the user interface of UE 310 where, for example, the user may key in additional information (e.g., type of emergency, number of injured parties, etc.) which is carried by the data channel back to and displayed in a user interface of PSAP 370.

FIG. 4B illustrates workflow 410 for data channel service for emergency services calls in the context of wireless communication networks in various implementations and referring to elements of operational environment 300 of FIG. 3A. Workflow 410 proceeds in a manner similar to workflow 400 but differs in that UE 310 advertises and invokes data channel service at the outset (i.e., when the NG911 call is first placed), thereby foregoing the Re-INVITE or UPDATE signaling. Once PSAP 370 accepts the offer of IMS DC service, UE 310 is prompted to accept the IMS DC service as well.

FIG. 4C illustrates workflow 420 for data channel service for emergency services calls in the context of wireless communication networks in various implementations and referring to elements of operational environment 300 of FIG. 3A. Workflow 420 proceeds in a manner similar to workflow 400 but differs in that a SIP UPDATE message is sent to UE 310 to add the IMS DC channel as the voice call is established.

FIG. 4D illustrates workflow 430 for data channel service for emergency services calls in the context of wireless communication networks in various implementations and referring to elements of operational environment 300 of FIG. 3A. Workflow 430 proceeds in a manner similar to workflow 400 but differs in that the data channel is bootstrapped to the voice call after the voice call is underway.

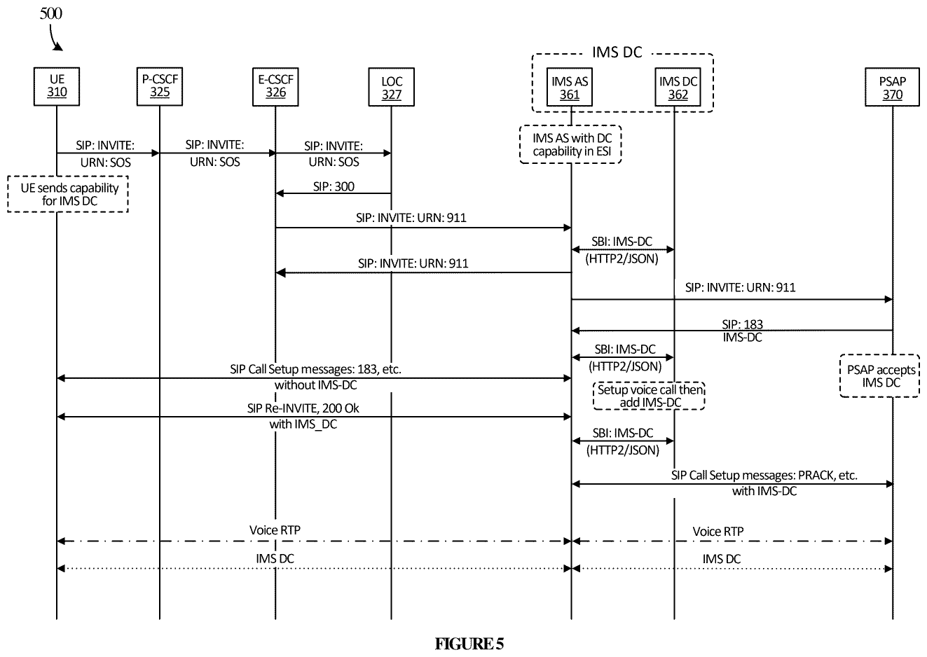

FIG. 5 illustrates workflow 500 for data channel service for emergency services calls in wireless communication networks in an implementation, referring to elements of operational environment 301 of FIG. 3B. The operational scenarios of operational environment 300 are similarly applicable in operational environment 301 but for the fact that IMS DC support is now anchored in ESInet 360 rather than in wireless communication network 320. In operational environment 301, signaling pertaining to establishing an IMS DC service between UE 310 and PSAP 370 occurs in conjunction with IMS AS 361 and IMS DC 362 (rather than TAS 328 and IMS DC 330 in FIG. 3A). Thus, the various call flow scenarios described in the context of operational environment 300 are applicable to operational environment 301 with no loss of generality.

In workflow 500, an NG911 call from UE 310 is received by access node 322 and routed through wireless communication network 320 to P-CSCF 325 which identifies or determines that the call is an emergency call necessitating emergency handling. The NG911 call also advertises IMS DC capability. P-CSCF 325 routes the NG911 call to E-CSCF 326 which obtains the location of UE 310 from location and routing function 327. Location and routing function 327 also identifies PSAP 370 based on the location of UE 310 and identifies ESInet 360 as the appropriate ESI network for connecting the NG911 call to PSAP 370.

Continuing with workflow 500, with PSAP 370 identified, E-CSCF 326 signals IMS AS 361 of ESInet 360 to establish a data channel bearer for the call. IMS AS 361 transmits a SIP INVITE including a request to accept data channel service to PSAP 370 (for example, relayed between the respective ISBCs of ESInet 360 and PSAP 370). Upon PSAP 370 relaying acceptance of data channel service with the voice call setup, IMS AS 361 signals IMS DC 362 to configure the IMS DC bearer to serve IMS DC media to UE 310 and PSAP 370 and sends a SIP 183 Session Progress (or INVITE Answer) to UE 310 accept the call, followed by a SIP Re-INVITE to accept data channel service. When UE 310 accepts data channel service, the voice bearer for the voice call is set up between UE 310 and PSAP 370 along with a data channel bearer for data channel service.

Data channel service can include the transmission of data (e.g., applications, webpages) to UE 310 and PSAP 370 from an application repository of IMS DC 362. For example, an operator at PSAP 370 may select an application to be transmitted to UE 310 for a capturing additional information relating to the call. When UE 310 accepts the application, the application may be displayed in the user interface of UE 310 where, for example, the user may key in additional information (e.g., type of emergency, number of injured parties, etc.) which is carried by the data channel back to and displayed in a user interface of PSAP 370.

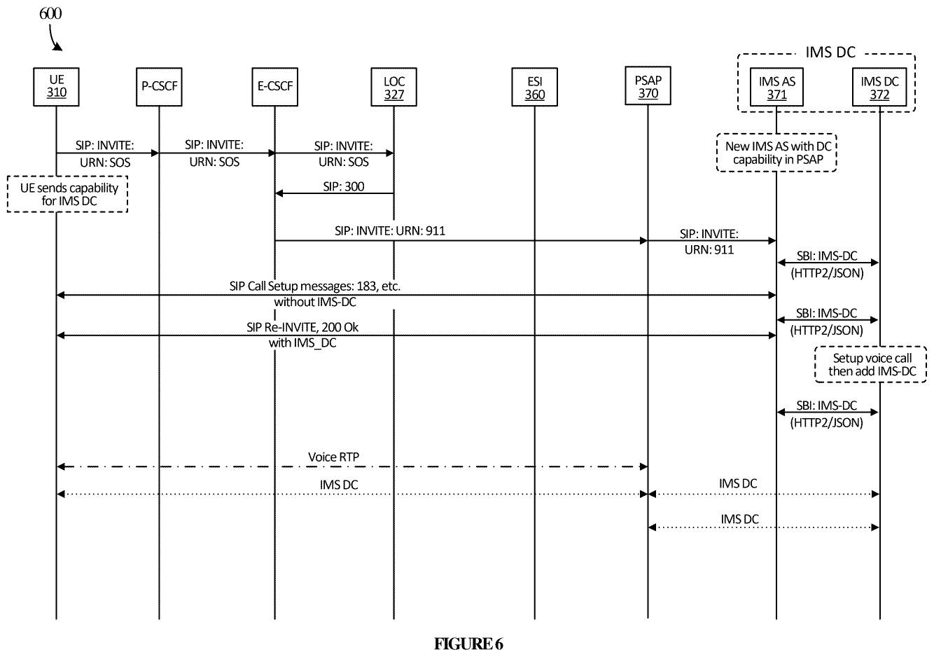

FIG. 6 illustrates workflow 600 for data channel services for emergency services calls in wireless communication networks in an implementation, referring to elements of operational environment 302 of FIG. 3C. The operational scenarios of operational environment 300 are similarly applicable in operational environment 302 but for the fact that IMS DC support is now anchored in PSAP 370 rather than in wireless communication network 320. In operational environment 302, signaling pertaining to establishing an IMS DC service between UE 310 and PSAP 370 occurs in conjunction with IMS AS 371 and IMS DC 372 (rather than IMS AS 128 and IMS DC 130 in FIG. 1). Thus, the various call flow scenarios described in the context of operational environment 300 are applicable to operational environment 302 with no loss of generality.

In workflow 600, an NG911 call from UE 310 is received by access node 322 and routed through wireless communication network 320 to P-CSCF 325 which identifies or determines that the call is an emergency call necessitating emergency handling. The NG911 call also advertises IMS DC capability. P-CSCF 325 routes the NG911 call to E-CSCF 326 which obtains the location of UE 310 from location and routing function 327. Location and routing function 327 also identifies PSAP 370 based on the location of UE 310 and identifies ESInet 360 as the appropriate ESI network for connecting the NG911 call to PSAP 370.

Continuing with workflow 600, with PSAP 370 identified, E-CSCF 326 signals IMS AS 371 of PSAP 370 to establish a data channel bearer for the call. IMS AS 371 signals IMS DC 372 to configure the IMS DC bearer to serve IMS DC media to UE 310 and PSAP 370 and sends a SIP 183 Session Progress (or INVITE Answer) to UE 310 accept the call, followed by a SIP Re-INVITE to accept data channel service. When UE 310 accepts data channel service, the voice bearer for the voice call is set up between UE 310 and PSAP 370 along with a data channel bearer for data channel service.

Data channel service can include the transmission of data (e.g., applications, webpages) to UE 310 and PSAP 370 from an application repository of IMS DC 372. For example, an operator at PSAP 370 may select an application to be transmitted to UE 310 for a capturing additional information relating to the call. When UE 310 accepts the application, the application may be displayed in the user interface of UE 310 where, for example, the user may key in additional information (e.g., type of emergency, number of injured parties, etc.) which is carried by the data channel back to and displayed in a user interface of PSAP 370.

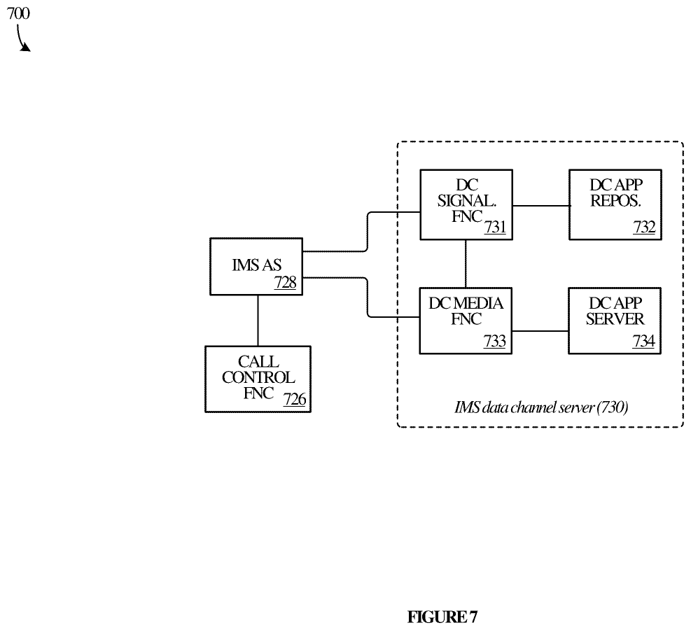

FIG. 7 illustrates operational architecture 700 for an IMS data channel server which can be interconnected to a wireless communication network, to an ESInet, or to a PSAP in various implementations. Operational architecture 700 includes call control function 726, IMS AS 728, and IMS DC server 730. IMS DC server 730 includes DC signaling function 731, DC application repository 732, DC media function 733, and DC application server 734.

Call control function 726 is representative of a network function such as an E-CSCF of a wireless communication network or an ISBC of an ESInet or PSAP for routing emergency services calls (e.g., NG911 calls).

IMS AS 728 is representative of a network function such as a TAS or a dedicated application server with functionality for supporting IMS DC service including interfacing with an IMS DC server such as IMS DC server 730. IMS AS 728 handles tasks such as communicating with IMS core functions (e.g., P-CSCF, S-CSCF) to coordinate data channel establishment with ongoing multimedia sessions, such as voice or video calls, and interfacing with transport layer entities to allocate and configure bearers with the necessary QoS parameters to meet application requirements. In an implementation, IMS AS 728 also handles tasks such as coordinating the establishment, modification, and termination of IMS data channels to support specific applications or services, such as videoconferencing, translation, or transcription; managing session state and context for data applications; and running server-side components of applications that leverage IMS data channels, such as file sharing, messaging, or advanced analytics.

IMS DC server 730 is representative of a network functionality implemented in software or hardware for establishing a data channel bearer in association with IMS voice calls including NG911 calls. IMS DC server 730 includes functionality for communication with an application server with data channel support or capability. IMS DC server 730 includes DC signaling function 731, DC application repository 732, DC media function 733, and DC application server 734.

DC signaling function 731 is representative of a network functionality implemented in software or hardware for managing the signaling and control plane processes required to establish, modify, and release IMS data channels including coordinating with IMS AS 728.

DC application repository 732 is representative of a network functionality implemented in software or hardware for storing, managing, and provisioning applications to support and enhance emergency 911 calls including NG911 within an IMS framework including maintaining a repository of specialized applications that are pre-configured for deployment and integration during emergency call sessions. DC application repository 732 handles tasks such as securely storing applications tailored for emergency use cases, such as real-time location tracking, medical alert systems, video streaming for situational awareness, and text-based communication for accessibility and enabling on-demand delivery and activation of relevant applications during the establishment or progression of an NG911 call.

DC media function 733 is representative of a network functionality implemented in software or hardware for handling the media plane operations required to support IMS data channels, particularly for real-time or near-real-time multimedia services including processing, managing, and transmitting media streams associated with data channels for optimized performance and quality. DC media function 733 handles tasks such as managing the encoding, decoding, and transcoding of multimedia streams to ensure compatibility across different endpoints and networks and implementing QoS policies to prioritize media traffic, minimize latency, and reduce packet loss.

DC application server 734 is representative of a network functionality implemented in software or hardware for running server-side components of applications (e.g., WebRTC applications) hosted on IMS data channels including hosting and managing application logic that enables advanced services and features for IMS data channels in conjunction with IMS call sessions including NG911 call sessions.

In operation, in an implementation, when an NG911 call is received, call control function 726 handling the call signals IMS AS 728 to bootstrap an IMS data channel to the call. IMS AS 728 initiates the establishment of a data channel bearer associated with the call. Signaling by IMS AS 728 to DC signaling function 731 of IMS DC server 730 includes information such as relevant session context, such as a call identifier, user identifiers, and required Quality of Service (QoS) parameters.

Once the DC bearer is established, IMS DC server 730 responds to IMS AS 728 with confirmation details, including bearer identifiers and media transport parameters. During the NG911 call, DC application repository 732 may be consulted to identify and provision any applications relevant to the NG911 call, such as those supporting real-time data sharing or enhanced collaboration. For example, a dispatcher at the PSAP endpoint may select an application for deployment from a menu of applications stored by DC application repository 731. When an application is selected, DC application server 734 activates and integrates the application into the ongoing voice call session.

FIG. 8 illustrates exemplary wireless communication system 800 that serves wireless User Equipment (UE) 801. Wireless communication system 800 includes UE 801, WiFi Access Node (AN) 803, 5GNR RAN 805, Interworking Function (IWF) 835, Access and Mobility Management Function (AMF) 834, Authentication Server Function (AUSF) 831, Unified Data Management (UDM) 832, Policy Control Functions (PCFs) 833, Session Management Function (SMF) 836, User Plane Function (UPF) 837, Uniform Data Repository (UDR) 838, and Application Function (AF) 850. UDR 838 stores network data including subscriber profiles including identities, subscription details, service preferences, authentication credentials, and billing information. UDR 838 may also store policy data such as network rules, access rules, mobility rules, charging rules, and so on. AF 850 may provide policies applicable to control plane functions, that is, to the application, presentation, and/or session layers of the OSI protocol stack. IWF 835 includes non-3GPP IWFs (N3IWFs) for providing untrusted non-3GPP access to network data center 810, such as access via a non-cellular access network.

Continuing with wireless communication system 800, wireless network slice 840 includes UPF 837 and SMF 836. Wireless network slice 840 is representative of a dynamically allocated slice of finite duration selected for hosting service from DN 860 to UE 801 according to the technology disclosed herein, including process 200 or workflows 400, 410, 420, 430, 500, and 600. DN 860 is representative of a data network, Internet access, third-party resource, or other endpoint of an end-to-end communication path from UE 801. For example, DN 860 may be an application or application service for supporting IMS DC services for NG911 calls for the wireless network of network data center 810 for service to UE 801.

FIG. 9 illustrates exemplary network data center 930, a network core of a wireless communication system, of which wireless communication network 120 of FIG. 1 and wireless communication network 320 of FIGS. 3A-3C are representative. Network data center 930 includes network function (NF) software 905, network function virtual layer 904, network function operating systems 903, network function hardware drivers 902, and network function hardware 901.

Network function software 905 of network data center 930 includes software for executing various network functions: IWF software 907, AMF software 909, UDM software 911, PCF software 913, SMF software 915, UPF software 917, and UDR software 919. Other network function software, such as network repository function (NRF) software, are typically present but are omitted for clarity.

Network function virtual layer 904 includes virtualized components of network data center 930, such as virtual NIC 951, virtual CPU 952, virtual RAM 953, virtual drive 954, virtual software 955, and virtual GPU 956. Network operating systems 903 includes components for operating network data center 930, including kernels 961, modules 962, applications 963, and containers 964 for network function software execution. Network function hardware drivers 902 include software for operating network function hardware 901 of network data center 930, including network interface card (NIC) drivers 971 for network interface cards (NICs) 981, CPU drivers 972 for CPUs 982, RAM drivers 973 for RAM 983, flash/disk drive drivers 974 for flash/disk drives 984, data switch (DSW) drivers 975 for data switches 985, and drivers 976 for GPUs 986. Network interface cards 981 of network function hardware 901 include hardware components for communicating with WiFi access node 991, 5GNR access node 992, PCF 993, application server 994, and UPF 995.

FIG. 10 illustrates computing device 1001 that is representative of any system or collection of systems in which the various processes, programs, services, and scenarios disclosed herein may be implemented. Examples of computing device 1001 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 1001 may be implemented as a single apparatus, system, or device or may be implemented in a distributed manner as multiple apparatuses, systems, or devices. Computing device 1001 includes, but is not limited to, processing system 1002, storage system 1003, software 1005, communication interface system 1007, and user interface system 1009 (optional). Processing system 1002 is operatively coupled with storage system 1003, communication interface system 1007, and user interface system 1009.

Processing system 1002 loads and executes software 1005 from storage system 1003. Software 1005 includes and implements data channel services process 1006, which is (are) representative of the data channel services processes discussed with respect to the preceding Figures, such as process 200 and workflows 400, 410, 420, 430, 500, and 600. When executed by processing system 1002, software 1005 directs processing system 1002 to operate as described herein for at least the various processes, operational scenarios, and sequences discussed in the foregoing implementations. Computing device 1001 may optionally include additional devices, features, or functionality not discussed for purposes of brevity.

Referring still to FIG. 10, processing system 1002 may comprise a micro-processor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, application specific processors, and logic devices, as well as any other type of processing device, combinations, or variations thereof.

Storage system 1003 may comprise any computer readable storage media readable by processing system 1002 and capable of storing software 1005. Storage system 1003 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 (including data channel services process 1006) may be implemented in program instructions and among other functions may, when executed by processing system 1002, direct processing system 1002 to operate as described with respect to the various operational scenarios, sequences, and processes illustrated herein. For example, software 1005 may include program instructions for implementing a data channel services process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. Software 1005 may also comprise firmware or some other form of machine-readable processing instructions executable by processing system 1002.

In general, software 1005 may, when loaded into processing system 1002 and executed, transform a suitable apparatus, system, or device (of which computing device 1001 is representative) overall from a general-purpose computing system into a special-purpose computing system customized to support data channel services for emergency services calls in an optimized manner. Indeed, encoding software 1005 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method, comprising:
by a call control function in a wireless communication network:
connecting an emergency services call between a first endpoint and a second endpoint, wherein the first endpoint comprises a calling device associated with a caller having an emergency, wherein the second endpoint comprises a public safety answering point (PSAP), and wherein connecting the emergency services call comprises:
receiving, from the first endpoint, the emergency services call to the second endpoint, wherein the emergency services call comprises an indication of data channel capability of the first endpoint;
establishing emergency voice call service between the first endpoint and the second endpoint;
offering data channel service to the second endpoint;
receiving acceptance of the data channel service from the second endpoint; and
establishing a data channel between the first endpoint and the second endpoint in association with the emergency voice call service.

2. The method of claim 1, wherein establishing the data channel comprises establishing the data channel by a data channel server of the wireless communication network in response to the data channel server receiving a request for the data channel from the call control function.

3. The method of claim 1, wherein the call control function comprises an Emergency Call Session Control Function (E-CSCF) of the wireless communication network.

4. The method of claim 1, wherein offering the data channel service to the second endpoint comprises offering the data channel service to the second endpoint based on receiving a confirmation of data channel capability of the second endpoint from a routing function of the wireless communication network.

5. The method of claim 1, wherein establishing the data channel comprises establishing the data channel after a voice bearer for the emergency services call is established between the first endpoint and the second endpoint.

6. The method of claim 1, further comprising offering the data channel service to the first endpoint after receiving acceptance of the data channel service from the second endpoint.

7. The method of claim 1, wherein the emergency services call comprises a Next Generation 911 (NG911) call.

8. The method of claim 1, wherein the emergency services call from the first endpoint further comprises a request for Internet Protocol Multimedia Service (IMS) data channel service.

9. The method of claim 1, wherein the data channel comprises Internet Protocol Multimedia Service (IMS) data channel.

10. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
connect, by a call control function of a wireless communication network, an emergency services call between a first endpoint and a second endpoint, wherein to connect the emergency services call, the program instructions direct the computing apparatus to:
receive, from a first endpoint, the emergency services call to the second endpoint, wherein the emergency services call comprises an indication of data channel capability of the first endpoint;
offer data channel service to the second endpoint;
receive acceptance of the data channel service from the second endpoint; and
establish a data channel between the first endpoint and the second endpoint in association with the emergency services call.

11. The computing apparatus of claim 10, wherein to establish the data channel, the program instructions direct the computing apparatus to establish the data channel by a data channel server of the wireless communication network in response to the data channel server receiving a request for the data channel from the call control function.

12. The computing apparatus of claim 10, wherein the call control function comprises an Emergency Call Session Control Function (E-CSCF) of the wireless communication network.

13. The computing apparatus of claim 10, wherein to offer the data channel service to the second endpoint, the program instructions direct the computing apparatus to offer the data channel service to the second endpoint based on receiving a confirmation of data channel capability of the second endpoint from a routing function of the wireless communication network.

14. The computing apparatus of claim 10, wherein to establish the data channel, the program instructions direct the computing apparatus to establish the data channel after a voice bearer for the emergency services call is established between the first endpoint and the second endpoint.

15. The computing apparatus of claim 10, wherein the program instructions further direct the computing apparatus to offer the data channel service to the first endpoint after receiving acceptance of the data channel service from the second endpoint.

16. The computing apparatus of claim 10, wherein the emergency services call comprises a Next Generation 911 (NG911) call and wherein the data channel comprises Internet Protocol Multimedia Service (IMS) data channel.

17. The computing apparatus of claim 10, wherein the emergency services call from the first endpoint further comprises a request for Internet Protocol Multimedia Service (IMS) data channel service.

18. One or more computer readable storage media having program instructions stored thereon that, when executed by one or more processors, direct a computing device to at least:
connect, by a call control function of a wireless communication network, an emergency services call between a first endpoint and a second endpoint, wherein to connect the emergency services call, the program instructions direct the computing device to:
receive, from a first endpoint, the emergency services call to the second endpoint, wherein the emergency services call comprises an indication of data channel capability of the first endpoint;
offer data channel service to the second endpoint;
receive acceptance of the data channel service from the second endpoint; and
establish a data channel between the first endpoint and the second endpoint in association with the emergency services call.

19. The one or more computer readable storage media of claim 18, wherein to establish the data channel, the program instructions direct the computing device to establish the data channel by a data channel server of the wireless communication network in response to the data channel server receiving a request for the data channel from the call control function.

20. The one or more computer readable storage media of claim 18, wherein to offer the data channel service to the second endpoint, the program instructions direct the computing device to offer the data channel service to the second endpoint based on receiving a confirmation of data channel capability of the second endpoint from a routing function of the wireless communication network.
